(19) United States
(12) Patent Application Publication
(10) Pub. No.: US 2021/0140008 A1
(43) Pub. Date: May 13, 2021

(54) METHOD FOR PRODUCING A HOT OR COLD STRIP AND/OR A FLEXIBLY ROLLED FLAT STEEL PRODUCT MADE OF A HIGH-STRENGTH MANGANESE STEEL AND FLAT STEEL PRODUCT PRODUCED BY SAID METHOD

(71) Applicant: Salzgitter Flachstahl GmbH, Salzgitter (DE)

(72) Inventors: PETER PALZER, Liebenburg (DE); THOMAS EVERTZ, Peine (DE); MANUEL OTTO, Cremlingen (DE); KAI KÖHLER, Nordstemmen (DE)

(73) Assignee: Salzgitter Flachstahl GmbH, Salzgitter (DE)

(21) Appl. No.: 16/333,920

(22) PCT Filed: Sep. 12, 2017
(86) PCT No.: PCT/EP2017/072889

§ 371 Date: Mar. 15, 2019

(30) Foreign Application Priority Data
Sep. 16, 2016 (DE) 10 2016 117 502.1

(51) Int. Cl. C21D 9/52; C21D 8/02; C21D 6/00; C22C 38/58; C22C 38/54; C22C 38/52; C22C 38/50; C22C 38/46; C22C 38/44; C22C 38/42; C22C 38/06; C22C 38/02; C22C 38/00; C23C 2/02; C23C 2/06; C23C 2/40; B32B 15/01

(52) U.S. Cl. CPC C21D 9/52; B32B 15/013; C21D 8/0226; C21D 8/0263; C21D 6/002; C21D 6/005; C21D 6/008; C22C 38/58; C22C 38/54; C22C 38/52; C22C 38/50; C22C 38/46; C22C 38/44; C22C 38/42; C22C 38/06; C22C 38/02; C22C 38/008; C22C 38/002; C23C 2/02; C23C 2/06; C23C 2/40; C21D 8/0205

(57) ABSTRACT

In a method for producing a flat steel product made of high-strength manganese steel, a hot or cold strip is provided with an alloy composition containing (in wt %): C: 0.0005 to 0.9; Mn: 4 to 12; Al: up to 10; P: <0.1; S: <0.1; N: <0.1; the remainder being iron, including unavoidable steel-alloying elements, with optional addition of one or more of the following elements (in wt %): Si: up to 6; Cr: up to 6; Nb: up to 1; V: up to 1.5; Ti: up to 1.5; Mo: up to 3; Sn: up to 0.5; Cu: up to 3; W: up to 5; Co: up to 8; Zr: up to 0.5; Ta: up to 0.5; Te: up to 0.5, B: up to 0.15. The hot or cold strip is flexibly rolled to a final thickness at a temperature of 60° C. to below Ac3 prior to a first rolling step.

The invention relates to a method for producing a flexibly rolled flat steel product consisting of a high-strength, manganese-containing steel having a TRIP and/or TWIP effect and an increased resistance to hydrogen-induced delayed crack formation (delayed fracture) and to hydrogen embrittlement. Flexibly rolled flat steel products can be provided e.g. as steel strips or steel sheets, wherein a hot strip or cold strip can be used as a semi-finished product for flexible rolling. The content of manganese is between 4 and 12 wt. % in these steels. The invention also relates to a method for producing a hot strip or cold strip consisting of a high-strength, manganese-containing steel and to a flat steel product which is flexibly roiled according to the method.

In conjunction with the present invention, “flexible rolling” is understood to mean a method for producing flat steel products in which a flat steel product having different thicknesses is produced in virtually any sequence in the rolling direction via an adjustable nip. Thickness differences of up to 50% can be achieved within a flexibly rolled flat steel product; the homogeneous transition between two constant thicknesses is advantageous. The flat steel product produced via flexible rolling is preferably used in order to then be deformed, in terms of a pre-fabricated semi-finished product, e.g. by deep drawing or roll profiling to form a desired component. The deformed components are used in various ways in the automotive industry e.g. to produce vehicle bodies. The flexible rolling advantageously ensures that the flexibly rolled flat steel product has thickness profiles which are adapted, in terms of loading, to the component to be subsequently deformed therefrom, whereby a saving is accordingly made in material and weight and optionally more components can be integrated with each other without additional joining processes, which leads to lower production costs. In particular, components which are subjected to different loading over their length are considered.

European patent application EP 2 383 353 A2 discloses a high-strength, manganese-containing steel, a flat steel product formed from this steel and a method for producing this flat steel product. The steel consists of the elements (contents in wt. % and relate to the steel melt): C: to 0.5; Mn: 4 to 12.0; Si: up to 1.0; Al: up to 3.0; Cr: 0.1 to 4.0; Cu: up to 4.0; Ni: up to 2.0; N: up to 0.05; P: up to 0.05; S: up to 0.01, with the remainder being iron and unavoidable impurities. Optionally, one or more elements from the group “V, Nb, Ti” are provided, wherein the sum of the contents of these elements is at most equal to 0.5. This steel is said to be characterised in that it can be produced in a more cost-effective manner than high manganese steels and at the same time has high elongation at fracture values and, associated therewith, a considerably improved deformability. A method for producing a flat steel product from the high-strength, manganese-containing steel described above comprises the following working steps: —melting the above-described steel melt, —producing a starting product for subsequent hot rolling, in that the steel melt is cast into a string from which at least one slab or thin slab is separated off as a starting product for the hot rolling, or into a cast strip which is supplied to the hot rolling process as a starting product, —heat-treating the starting product in order to bring the starting product to a hot rolling starting temperature of 1150 to 1000° C., —hot rolling the starting product to form a hot strip having a thickness of at most 2.5 mm, wherein the hot rolling is terminated at a hot rolling final temperature of 1050 to 800° C., —reeling the hot strip to form a coil at a reeling temperature of ≤700° C. Optionally, the hot strip can be annealed at 250 to 950° C., subsequently cold rolled and then annealed at 450 to 950° C. The possibility of flexible rolling is not mentioned.

Furthermore, German patent document DE 10 2012 110 972 B3 discloses a method for producing a product from flexibly rolled strip material. The flexible rolling is performed as a cold rolling process. By means of flexibly rolling, a flexibly rolled strip material is produced from a strip material having a substantially constant thickness and has a thickness which can vary over the length of the strip material. An alloy composition for the flexibly rolled strip material is not mentioned.

The patent application US 2015/0147589 A1 describes the flexible rolling of steel strips to produce strip material having at least two different thicknesses along the steel strip. The flexible rolling is performed as flexible cold rolling. Extracts of an alloy composition for the flexibly rolled strip material contains (contents in wt. %); C: ≤0.1; Mn: 0.5 to 7; Al: ≤0.1; P: ≤0.03; S: <0.005; N: ≤0.008; with the remainder being iron and process-induced impurities.

European patent specification EP 1 238 727 B1 discloses a method for producing metallic strips comprising portions of different material properties. The metallic strips are produced in a two-roller casting machine and strip-shaped portions of different material properties are achieved by different cooling rates. In order to carry out this method, low-alloyed or micro-alloyed steel alloys can be used which typically contain extracts of the following composition (contents in wt. %): a 0.01 to 0.8; Mn: 0.3 to 5; Al: ≤0.1 and the remainder being iron and smelting-induced impurities. A strip produced according to this method can be used as a precursor material for flexible rolling.

Furthermore, German laid-open document DE 10 2012 013 113 A1 already describes so-called TRIP steels which have a predominantly ferritic basic microstructure having incorporated residual austenite which can convert into martensite during deformation (TRIP effect). Owing to its intense cold-hardening, TRIP steels achieve high values for uniform elongation and tensile strength. TRIP steels are used inter alia in structural components, chassis components and crash-relevant components of vehicles, as sheet metal blanks, tailored blanks (welded blanks) and as flexibly cold-rolled strips, so-called tailored rolled blanks (TRBs). The flexibly cold-rolled strips allow a significant reduction in weight because the sheet metal thickness is adapted to the loading over the length of the component. The steel has a manganese content of 1 to 2.25 wt. %.

The problem with the production of flexibly cold-rolled flat steel products consisting of a high-strength, manganese-containing steel is the strong tendency towards cold-hardening during the flexible rolling which greatly increases the deformation forces and thereby limits the maximum degree of deformation. Moreover, the known manganese-containing steel has a restricted, maximum rolling degree of deformation by reason of the more rapidly commencing martensite formation during deformation at room temperature. Furthermore, the residual deformation capability of the flat steel product produced in this manner is greatly reduced and so, prior to further processing by deformation technology, costly annealing to restore deformability is occasionally required.

Proceeding therefrom, the object of the present invention is to provide a method for producing a flexibly rolled flat steel product consisting of a high-strength, manganese-containing steel with a TRIP and/or TWIP effect, in particular for producing a flexibly rolled flat steel product which, during flexible rolling, achieves a high maximum degree of deformation and in relation to the steel provides a good combination of strength and deformation properties and a high residual deformation capability of the flexibly rolled flat steel product. The flat steel product produced in this manner is also to have a high resistance to hydrogen-induced delayed crack formation, hydrogen embrittlement and to liquid metal embrittlement during welding.

This object is achieved by a method for producing a flexibly rolled flat steel product consisting of a high-strength, manganese-containing TRIP and/or TWIP steel comprising the features of claim 1. Advantageous embodiments of the invention are described in the dependent claims. A flat steel product in accordance with the invention is provided comprising the features of claim 11. A use of the flat steel product produced in this manner is provided comprising the features of claim 13.

In accordance with the invention, a method for producing a flexibly rolled flat steel product having a final thickness required in sections and consisting of a high-strength, manganese-containing steel, comprising the steps of:

providing a hot strip or cold strip, galvanised or non-galvanised, having an alloy composition containing (in wt. %): C: 0.0005 to 0.9; Mn; 4 to 12; Al: to 10; P: <0.1; S: <0.1; N: <0.1; with the remainder being iron including unavoidable steel-associated elements, with optional adding by alloying of one or more of the following elements (in wt. %): Si: to 6; Cr: to 6; Nb: to 1; V: to 1.5; Ti: to 1.5; Mo: to 3; Sn: to 0.5; Cu: to 3; W: to 5; Co: to 8; Zr: 0.5; Ta: to 0.5; Te: to 0.5; B: to 0.15,

flexibly rolling the hot strip or cold strip in a rolling step or in a plurality of rolling steps to the final thicknesses required in sections at a temperature of the hot strip or cold strip of 60° C. to below Ac3, preferably of 60° C. to 450° C., prior to the first rolling step, wherein this feature is understood to mean that, prior to the first rolling step, the desired temperature is already reached and is not produced only by the rolling per se,

optionally galvanising the as yet non-galvanised flat steel product thus produced, provides a flat steel product which, during flexible rolling, achieves a high maximum degree of deformation and in relation to the steel provides a good combination of strength and deformation properties and a high residual deformation capability of the flexibly rolled flat steel product, as well as an increased resistance to delayed crack formation, hydrogen embrittlement and liquid metal embrittlement, which additionally has a TRIP and/or TWIP effect during mechanical loading.

In a particularly preferred manner, the hot strip or cold strip is preheated, prior to the first rolling step, to a temperature of 60° C. to below Ac3, preferably of 60° C. to 450° C.

In an advantageous manner, provision is also made that, with the exception of the first rolling step, the hot strip or cold strip is flexibly rolled in the following rolling steps at the same or different temperatures of the hot strip or cold strip of room temperature to below Ac3, advantageously at room temperature to below 450° C., In a specific procedure, provision is made that the hot strip or cold strip is flexibly rolled in the first rolling step and the following rolling steps at the same temperatures of the hot strip or cold strip of 60° C. to below Ac3, advantageously at 60° C. to below 450° C.

In conjunction with the present invention, room temperature is defined as lying in the range between 15 to 25° C.

Following on from the procedure of warm rolling with preheating, the last rolling step or a plurality of last rolling steps can optionally be performed during a plurality of required rolling steps at temperatures, optionally locally limited, from 9100 to 60° C. and metastable austenite can thus be converted in a targeted manner into martensite. As a result, the strength in the finally formed semi-finished product or product can be increased in a target-oriented manner.

By using the described, manganese-containing steel, the method in accordance with the invention can achieve the following:

increase the maximum degree of deformation of the flexibly rolled medium manganese steel by reducing the hardening during the flexible rolling

specifically adjust strength and elongation properties by varying the deformation temperature.

The hot strip or cold strip required for producing the flat steel product for flexible rolling can be advantageously produced by the steps of:

melting a steel melt having an alloy composition containing (in wt. %); C: 0.0005 to 0.9; Mn: 4 to 12; Al: to 10; P: <0.1; S: <0.1; N: <0.1; with the remainder being iron including unavoidable steel-associated elements, with optional adding by alloying of one or more of the following elements (in wt. %): Si: to 6; Cr: to 6; Nb: to 1; V: to 1.5; Ti: to 1.5; Mo: to 3; Sn: to 0.5; Cu: to 3; W: to 5; Co: to 8; Zr: 0.5; Ta: to 0.5; Te: to 0.5: B: to 0.15, via the process route, blast furnace steel plant or electric arc furnace steel plant with optional vacuum treatment of the melt:

casting the steel melt to form a pre-strip by means of a horizontal or vertical strip casting process approximating the final dimensions or casting the steel melt to form a slab or thin slab by means of a horizontal or vertical slab or thin slab casting process,

heating the pre-strip or the slab or the thin slab to a temperature of 1050 to 1250° C. or in-line rolling out of the casting heat,

hot rolling to a uniform final thickness of 20 to 0.8 mm at a final rolling temperature of 1050 to 800° C.,

reeling the hot strip at a reeling temperature of more than 100 to 800° C.,

acid-cleaning the hot strip

annealing the hot strip at a temperature of 500 to 840° C., for a time of 1 min to 24 h in a continuous or batch-type annealing process,

optionally cold rolling the hot strip to a uniform final thickness at room temperature or elevated temperature in one or a plurality of rolling passes, optionally annealing the cold-rolled hot strip at a temperature of 500 to 840° C. for 1 min to 24 h in continuous or batch-type annealing process

optionally electrolytically galvanising or hot-dip galvanising the hot strip or cold strip or applying another metal, organic or inorganic coating before or after the flexible rolling.

In one advantageous development of the invention, provision is made that the cold rolling is performed at a temperature prior to the first rolling step of 60° C. to below the Ac3 temperature, preferably of 60 to 450° C., and heating or cooling is performed between the rolling passes to 60° C. to below the Ac3 temperature, preferably to 60 to 450° C. The cold rolling at elevated temperature is advantageous in order to reduce the rolling forces and to aid the formation of deformation twins (TWIP effect).

Furthermore, provision is made that, in order to restore sufficient deformation properties the cold-rolled strip is subsequently annealed at a temperature of 500 to 840° C. for 1 min to 24 h in a continuous or batch-type annealing process.

In the context of the above method in accordance with the invention, a pre-strip produced with the two-roller casting process and approximating the final dimensions and having a thickness of less than or equal to 3 mm, preferably 1 mm to 3 mm is already understood to be a hot strip with a unitary thickness. The pre-strip thus produced as a hot strip with a unitary thickness does not have an original cast structure owing to the introduced deformation of the two rollers running in opposite directions. Hot rolling thus already takes place in-line during the two-roller casting process which means that separate hot rolling is not necessary.

The hot strip is annealed at an annealing temperature of 500 to 840° C. and an annealing duration of 1 minute to 24 hours. Higher temperatures are associated with shorter treatment times and vice versa. Annealing can take place both e.g., in a batch-type annealing process (longer annealing times) and e.g. in a continuous annealing process (shorter annealing times). By way of the annealing, approximately homogeneous mechanical properties can be set in the different thickness ranges of the flexibly rolled flat steel product, said properties ensuring good processability in the subsequent deformation process.

The flexible rolling of the hot strip or cold strip is performed in accordance with the invention after initial deformation in the range of 60° C. to below Ac3, preferably 60° C. to 450° C. in one or a plurality of passes or rolling steps, whereby during the rolling procedure a conversion of metastable austenite into martensite (TRIP effect) is completely or partially suppressed and wherein deformation twins can form in the austenite (TWIP effect) which then considerably increase the deformation capability. This effect advantageously produces a reduction in the rolling forces and increases the overall deformation capability.

Furthermore, the final product which is flexibly rolled at elevated temperature has, with the same degree of deformation, at least the same or higher strength properties (yield strength/elasticity limit and/or tensile strength) as/than the final product which is flexibly rolled at room temperature, wherein the elongation at fracture is at least 5% or even 10% higher in comparison with the flexible rolling at room temperature. In a similar manner, it is possible to set comparable characteristic values for the elongation at fracture, wherein the characteristic value for the strength (yield strength/elasticity limit and/or tensile strength) is, in comparison, 10% above the characteristic values of flexible rolling at room temperature.

Finally, after flexible rolling at elevated temperature one or a plurality of rolling steps can be performed at temperatures, which can also be locally limited, of 100 to 60° C., wherein metastable austenite is converted in a targeted manner into martensite and the strength in the region concerned is considerably increased.

The inventive method for flexibly rolling this material at elevated temperatures results as a whole, via optimisation of the metallurgy, hot rolling conditions and the temperature-time parameters in the annealing system, in a cold strip or hot strip which is particularly well suited for subsequent flexible rolling. In particular, the rolling forces during flexible rolling are reduced and the maximum degree of deformation is thereby increased. The flexibly rolled flat steel product also has an increased residual deformation capability which renders superfluous any otherwise necessary annealing, such as e.g. recrystallisation annealing of the material after flexible rolling.

Furthermore, in accordance with the invention, strengths and residual elongations can be adapted locally by means of local heating/cooling during flexible rolling, wherein primarily higher strengths are achieved by means of targeted cooling and higher residual elongations are achieved by means of local heating.

By reason of the elevated temperature prior to the rolling procedure, deformation twins (TWIP effect) are introduced in a targeted manner which are then converted into martensite at room temperature and as a result increase the energy absorption capability and permit a higher degree of deformation. Flat steel products produced in this manner have an increased resistance to hydrogen-induced embrittlement and delayed crack formation because the TRIP effect is at least partially suppressed.

Preferably, the flexibly rolled flat steel product is galvanised by hot-dipping or electrolytically or is coated metallically, inorganically or organically. In the event that already galvanised hot strips or cold strips are to be flexible rolled, the heating temperature prior to rolling is optionally advantageously limited to 60 to 450° C. in order to substantially prevent liquefaction of zinc. Moreover, the zinc coat is also subjected merely to low thermal loading during warm-forming below 450° C., whereby cathodic corrosion protection of the coat is still ensured even after the forming process.

Good weldability is also provided. Moreover, the production of this manganese steel in accordance with the invention having a medium manganese content (medium manganese steel) on the basis of the alloy elements C and Mn is very cost-effective.

The steel in accordance with the invention is an alloy which has a TRIP and/or TWIP effect which improves the deformability and the tensile strength. Furthermore, component failure in the event of excess loads is hereby attenuated in that the component is locally deformed, wherein stresses are dissipated and as a result sudden failure, e.g. by the component breaking, is reduced.

A flat steel product which is produced and flexibly rolled according to the method in accordance with the invention has a tensile strength Rm of more than 1000 MPa and an elongation at fracture A50 of more than 3% to 45% in the most greatly deformed regions of the flat steel product.

With regard to the alloy composition for achieving the desired effects, the following element contents have proven to be particularly advantageous:

### C: 0.05 to 0.35

### Mn: >5 to <10

Al: 0.05 to 5, in particular >0.5 to 3
selectively in combination with
Si: 0-6, preferably 0.05-3, particularly preferably 0.1-1.5
Cr: 0-6, preferably 0.1-4, particularly preferably >0.5-2.5
Nb: 0-1, preferably 0.005-0.4, particularly preferably 0.01-0.1
V: 0-1.5, preferably 0.005-0.6, particularly preferably 0.01-0.3
Ti: 0-1.5, preferably 0.005-0.6, particularly preferably 0.01-0.3
Mo: 0-3, preferably 0.005-1.5, particularly preferably 0.01-0.6
Sn: 0-0.5, preferably <0.2, particularly preferably <0.05
Cu: 0-3, preferably <0.5, particularly preferably <0.1
W: 0-5, preferably 0.01-3, particularly preferably 0.2-1.5
Co: 0-8, preferably 0.01-5, particularly preferably 0.3-2
Zr: 0-0.5, preferably 0.005-0.3, particularly preferably 0.01-0.2
Ta: 0-0.5, preferably 0.005-0.3, particularly preferably 0.01-0.1
Te: 0-0.5, preferably 0.005-0.3, particularly preferably 0.01-0.1
B: 0-0.15, preferably 0.001-0.08, particularly preferably 0.002-0.01.

Alloy elements are generally added to the steel in order to influence specific properties in a targeted manner. An alloy element can thereby influence different properties in different steels. The effect and interaction generally depend greatly upon the quantity, presence of further alloy elements and the solution state in the material. The correlations are varied and complex. The effect of the alloy elements in the steel in accordance with the invention will be discussed in greater detail hereinafter. The positive effects of the alloy elements used in accordance with the invention will be described hereinafter.

The use of the term to in the definition of the content ranges, such as e.g. 0.005 to 0.6 wt. %, means that the limit values—0.005 and 0.6 in the example—are also included.

Carbon C: C is required to form carbides, stabilises the austenite and increases the strength. Higher contents of C impair the welding properties and result in the impairment of the elongation and toughness properties in the steels in accordance with the invention, for which reason a maximum content of 0.9 wt % is set. In order to achieve the desired strengths and minimum elongation at fracture values in combination, a minimum addition of 0.0005 wt. % is provided. Preferably, contents of 0.05 to 0.35 wt. % are provided.

Manganese Mn: Mn stabilises the austenite, increases the strength and the toughness and renders possible a deformation-induced martensite formation and/or twinning in the alloy in accordance with the invention. Contents of less than wt % are not sufficient to stabilise the austenite and therefore impair the elongation properties whereas with contents of over 12 wt. % the austenite is stabilised too much and as a result the strength properties, in particular the yield strength, are reduced. For the manganese steel in accordance with the invention having average manganese contents, a range of 4 to 12 wt. %, preferably more than 5 and less than 10 wt. %, is set.

Phosphorus P: P is a trace element, it originates predominately from iron ore and is dissolved in the iron lattice as a substitution atom. Phosphorous increases the strength and hardness by means of solid solution hardening and improves the hardenability. However, attempts are generally made to lower the phosphorous content as much as possible because inter alia it exhibits a strong tendency towards segregation owing to its low diffusion rate and greatly reduces the level of toughness. The attachment of phosphorous to the grain boundaries can cause cracks along the grain boundaries during hot rolling. Moreover, phosphorous increases the transition temperature from tough to brittle behaviour by up to 300° C. For the aforementioned reasons, the phosphorous content is limited to less then 0.1 wt %, preferably to less than 0.04 wt. %.

Sulphur S: Like phosphorous, S is bound as a trace element in the iron ore but in particular in the production route via the blast furnace process in the coke. It is generally not desirable in steel because it exhibits a strong tendency towards segregation and has a greatly embrittling effect. An attempt is therefore made to achieve amounts of sulphur in the melt which are as low as possible (e.g. by deep vacuum treatment). For the aforementioned reasons, the sulphur content is limited to less than 0.1 wt. %, preferably less than 0.02 wt. %.

Nitrogen N: N is likewise an associated element from steel production. In the dissolved state, it improves the strength and toughness properties in steels with a high manganese content of greater than or equal to 4 wt. % Mn. Lower Mn-alloyed steels of less than 4 wt. % Mn tend, in the presence of free nitrogen, to have a strong ageing effect. The nitrogen diffuses even at low temperatures to dislocations and blocks same. It thus produces an increase in strength associated with a reduction in toughness properties. Binding of the nitrogen in the form of nitrides is possible by adding e.g. aluminium, vanadium, niobium or titanium by alloying. For the aforementioned reasons, the nitrogen content is limited to less than 0.1 wt. %, preferably less than 0.05 wt. %.

Aluminium Al: As an optional alloy element, Al is added by alloying in contents of up to 10 wt. %. Al is used to deoxidise steels. Furthermore, an addition of Al advantageously improves the strength and elongation properties and positively influences the conversion behaviour of the alloy in accordance with the invention. Furthermore, an improvement in the cold-rollability could be seen by adding Al by alloying. Al contents of up to 10 wt. % reduce the specific weight of the steel considerably and thus contribute to the reduction in fuel consumption in motor vehicles. However, higher Al contents considerably impair the casting behaviour in the continuous casting process. This produces increased outlay when casting. Contents of Al of more than 5 wt. % also impair the elongation properties. Thus, a maximum content of 10 wt. % is set. Preferably, an alloy addition in the range of greater than 0.05 wt. % to 5 wt. % is set. In a particularly preferred manner, the minimum Al content is >0.5 wt % and the maximum content is 3 wt. %.

Silicon Si: Si impedes the diffusion of carbon, reduces the relative density and increases the strength and elongation properties and toughness properties. Furthermore, an improvement in the cold-rollability could be seen by adding Si by alloying. Contents of more than 6 wt. % result, in the alloys in accordance with the invention, in embrittlement of the material and negatively influence the hot- and cold-rollability and the coatability e.g. by galvanising. Thus, a maximum content of 6 wt % is set. Alloying in the range of 0.05 to 3 wt. %, particularly preferably in the range of 0.1 to 1.5 wt. %, is preferred.

Chromium Cr: Cr improves the strength and reduces the rate of corrosion, delays the formation of ferrite and perlite and forms carbides. The maximum content is optionally set to less than 6 wt,% since higher contents result in an impairment of the elongation properties. A Cr content of 0.1 to 4 wt. %, particularly preferably more than 0.5 to 2.5 wt. %, is preferred.

Microalloy elements are generally added only in very small amounts (<0.1 wt. % per element). In contrast to the alloy elements, they mainly act by precipitate formation but can also influence the properties in the dissolved state. Small added amounts of the mioroalloy elements already considerably influence the processing properties and final properties. Particularly in the case of hot-forming, microalloy elements advantageously influence the recrystallisation behaviour and effect grain refinement.

Typical microalloy elements are vanadium, niobium and titanium. These elements can be dissolved in the iron lattice and form carbides, nitrides or carbonitrides with carbon and nitrogen.

Vanadium V and niobium Nb: These act in a grain-refining manner in particular by forming carbides, whereby at the same time the strength, toughness and elongation properties are improved. Contents of more than 1 wt. % in the case of Nb and 1.5 wt % in the case of V do not provide any further advantages. Contents of 0.005 to 0.4 wt. % for Nb, preferably 0.01 to 0.1 wt. % and 0.005 to 0.6 wt. % for V, preferably 0.01 to 0.3 wt. % can optionally be added.

Titanium Ti: Ti acts in a grain-refining manner as a carbide-forming agent, whereby at the same time the strength, toughness and elongation properties are improved, and reduces the inter-crystalline corrosion. Contents of Ti of more than 1.5 wt. % impair the expansion and deformation properties in the alloys in accordance with the invention, for which reason a maximum content of 1.5 wt. % is optionally set. Minimum contents of of 0.005 to 0.8 wt,%, preferably 0.01 to 0.3 wt. % can optionally be added.

Molybdenum Mo: Mo acts as a strong carbide-forming agent and increases the strength and increases the resistance to delayed crack formation and hydrogen embrittlement. Contents of Mo of more than 3 wt. % impair the elongation properties, for which reason a maximum content of 3 wt. % and a minimum content of 0.005 to 1.5 wt. %, preferably 0.01 to 0.6 wt. %, is optionally set.

Tin Sn: Sn increases the strength but, similar to copper, accumulates beneath the scale layer and at the grain boundaries at higher temperatures. Owing to the penetration into the grain boundaries, it leads to the formation of low melting point phases and, associated therewith, to cracks in the microstructure and to solder brittleness, for which reason a maximum content of up to 0.5, preferably less than 0.2, particularly preferably less than 0.05 wt. %, is optionally set.

Copper Cu: Cu reduces the rate of corrosion and increases the strength. Contents of above 3 wt. % impair the producibility by forming low melting phases during casting and hot rolling, for which reason a maximum content of 3, preferably of less than 0.5, particularly preferably less than 0.1 wt. %, is optionally set.

Tungsten W: W acts as a carbide-forming agent and increases the strength and heat resistance. Contents of W of more than 5 wt % impair the elongation properties, for which reason a content of 0.01 to 3 wt. %, preferably 0.2 to 1.5 wt. %, is optionally set.

Cobalt Co: Co increases the strength of the steel, stabilises the austenite and improves the heat resistance. Contents of more than 8 wt. % impair the elongation properties in the alloys in accordance with the invention, for which reason a content of 0.01 to 5, preferably 0.3 to 2 wt %, is optionally set.

Zirconium Zr: Zr acts as a carbide-forming agent and improves the strength. Contents of Zr of more than 0.5 wt. % impair the elongation properties, for which reason a content of 0.3 wt,% and a minimum content of 0.005 wt. % are optionally set. A content of 0.01 to 0.2 wt,% is particularly preferred.

Tantalum Ta: Ta acts in a similar manner to niobium as a carbide-forming agent in a grain-refining manner and thereby improves the strength, toughness and elongation properties at the same time. Contents over 0.5 wt. % do not provide any further improvement in the properties. Thus, a maximum content of 0.5 wt. % is optionally set. Preferably, a minimum content of 0.005 and a maximum content of 0.3 wt. % are set, in which the grain refinement can advantageously be produced. In order to improve economic feasibility and to optimise grain refinement, a content of 0.01 wt. % to 0.1 wt. % is particularly preferably sought.

Tellurium Te: Te improves the corrosion-resistance and the mechanical properties and machinability. Furthermore, Te increases the solidity of MnS which, as a result, is lengthened to a lesser extent in the rolling direction during hot rolling and cold rolling. Contents above 0.5 wt. % impair the elongation and toughness properties, for which reason a maximum content of 0.5 wt % is set. Optionally, a minimum content of 0.005 wt. % and a maximum content of 0.3 wt. % are set, which advantageously improve the mechanical properties and increase the solidity of MnS present. Furthermore, a minimum content of 0.01 wt. % and a maximum content of 0.1 wt. % are preferred which render possible optimisation of the mechanical properties whilst at the same time reducing alloy costs.

Boron B: B improves the strength and stabilises the austenite. Contents of more than 0.15 wt. % result in embrittlement of the material. Therefore, in the steel in accordance with the invention Bis optionally added by alloying in the range of 0.001 wt. % to 0.08 wt. %. In a particularly preferred manner, a content is set to 0.002 to 0.01 wt. %.

The flat steel product in accordance with the invention described above is particularly suitable for producing flexibly rolled flat steel products which allow a reduction in weight and thus lower production costs and an increase in efficiency owing to the adapted sheet metal thickness profile. Flexibly rolled flat steel products are used e.g. in the automotive industry (vehicle bodies), agricultural engineering, rail vehicle construction, traffic engineering or in household appliances. Furthermore, the flat steel product in accordance with the invention is particularly suitable for use in tailored welded blanks.

Tests were performed in order to examine the mechanical properties of steel strips produced in accordance with the invention and consisting of an exemplary alloy 1. The alloy 1 contains, in addition to iron and melting-induced impurities, extracts of the following elements in the stated contents in wt. %:

| Alloy | C | Mn | Al | Si |
|---|---|---|---|---|
| Alloy 1 | 0.2 | 7.0 | 0.9 | 0.5 |

For the purposes of comparison, the steel strips produced from the above-mentioned alloy 1 were cold rolled, i.e. at room temperature and therefore below 50° C., and also rolled in accordance with the invention at 250′C. The stated properties are in dependence upon the degree of deformation e. The degree of deformation e is defined as the quotient of the change in thickness Δd of the steel strip under investigation and the initial thickness d0 of the steel strip under investigation. As is typical with flexible rolling, a plurality of cross-sections have been used. The different degrees of deformation represent different thicknesses in flexible rolling. The characteristic values can be achieved both by means of the hot strip (characteristic values at the hot strip) and also at the annealed cold strip. All of the characteristic values are stated for the alloy 1:

| | | | | Degree of |
|---|---|---|---|---|
| Rolling | Rp0.2 | | | deformation |
| temperature | [MPa] | Rm [MPa] | A50 [%] | (e = Δd/d0) [%] |
| RT (ca. 25° C.) | 601 | 904 | 29.5 | 0 |
| RT (ca. 25° C.) | 1222 | 1317 | 2.5 | 44 |
| 250° C. | 819 | 1070 | 27.9 | 17 |
| 250° C. | 1017 | 1141 | 22.2 | 32 |
| 250° C. | 1047 | 1296 | 20.3 | 44 |
| 250° C. | 1119 | 1418 | 17.6 | 54 |

1.-13. (canceled)

14. A method for producing a flat steel product of high-strength, manganese-containing steel, said method comprising:
flexibly roving in at least one roving step a hot strip or cold strip including an alloy composition containing (in wt. %): C: 0.0005 to 0.9; Mn: 4 to 12; Al: to 10; P: <0.1; S: <0.1; N: <0.1; with the remainder being iron including unavoidable steel-associated elements, at a temperature of the hot strip or cold strip of 60° C. to below Ac3, preferably of 60° C. to 450° C., to produce a flat steel product with a required final thickness.

15. The method of claim 14, further comprising adding by alloying at least one element selected from the group consisting of (in wt. %): Si: to 6; Cr: to 6; Nb: to 1; V: to 1.5; Ti: to 1.5; Mo: to 3; Sn: to 0.5; Cu: to 3; W: to 5; Co: to 8; Zr: to 0.5; Ta; to 0.5; Te: to 0.5: B: to 0.15.

16. The method of claim 14, further comprising galvanising the flat steel product.

17. The method of claim 14, further comprising preheating the hot strip or cold strip, prior to the rolling step, to a temperature of 60° C. to below Ac3, preferably of 60° C. to 450° C.

18. The method of claim 14, wherein the hot strip or cold strip is flexibly rolled in a plurality of rolling steps such that except for a first one of the rolling steps the hot strip or cold strip is flexibly rolled in the following rolling steps at a same or a different temperature of the hot strip or cold strip of room temperature to below Ac3, advantageously at room temperature to below 450° C.

19. The method of claim 14, wherein the hot strip or cold strip is flexibly rolled in a plurality of rolling steps such that in a first one of the rolling steps and the following rolling steps the hot strip or cold strip is flexibly rolled at a same temperature of the hot strip or cold strip of 60° C. to below Ac3, advantageously at 60° C. to below 450° C.

20. The method of claim 17, wherein the hot strip or cold strip is flexibly rolled in a plurality of rolling steps such that after a first one of the rolling steps with preheating, at least a last one of the rolling steps is performed at a temperature of −100 to 60° C.

21. The method of claim 20, wherein the temperature influences the flat steel product in a locally limited manner.

22. The method of claim 14, wherein the flat steel product is produced with a following alloy composition in wt. %:
C: 0.05 to 0.35,
Mn: >5 to <10,
Al: 0.05 to 5, in particular >0.5 to 3.

23. The method of claim 14, wherein the flat steel product is produced with a following alloy composition in wt. %:
Si: 0.05-3, preferably 0.1-1.5,
Cr: 0.1-4, preferably >0.5-2.5,
Nb: 0.005-0.4, preferably 0.01-0.1,
V: 0.005-0.6, preferably 0.01-0.3,
Ti: 0.005-0.6, preferably 0.01-0.3,
Mo: 0.005-1.5, preferably 0.01-0.6,
Sn: <0.2, preferably <0.05,
Cu: <0.5, preferably <0.1,
W: 0-5, 0.01-3, preferably 0.2-1.5,
Co: 0.01-5, preferably 0.3-2,
Zr: 0.005-0.3, preferably 0.01-0.2,
Ta: 0.005-0.3, preferably 0.01-0.1,
Te: 0.005-0.3, preferably 0.01-0.1,
B: 0.001-0.08, preferably 0.002-0.01.

24. A method for producing a hot strip or cold strip for producing a flexibly rolled flat steel product, said method comprising:
melting a steel melt having an alloy composition containing (in wt,%): C: 0.0005 to 0.9; Mn: 4 to 12; Al: to 10; P: <0.1; S: <0.1; N: <0.1; with the remainder being iron including unavoidable steel-associated elements, via a process route, blast furnace steel plant or electric arc furnace steel plant with optional vacuum treatment of the melt;
casting the steel melt to form a pre-strip by a horizontal or vertical strip casting process approximating a final dimension or casting the steel melt to form a slab or thin slab by a horizontal or vertical slab or thin slab casting process;
heating the pre-strip or the slab or the thin slab to a temperature of 1050 to 1250° C. or in-line rolling out of the casting heat (first heat);
hot rolling to a uniform final thickness of 20 to 0.8 mm at a final rolling temperature of 1050 to 800° C., thereby producing a hot strip;
reeling the hot strip at a reeling temperature of more than 100 to 800° C.;
acid-cleaning the hot strip; and
annealing the hot strip at a temperature of 500 to 840° C., for a time of 1 min to 24 h in a continuous or batch-type annealing process.

25. The method of claim 24, further comprising cold rolling the hot strip to a uniform final thickness at room temperature or elevated temperature in at least one rolling pass.

26. The method of claim 25, further comprising annealing the cold-rolled hot strip at a temperature of 500 to 840° C. for 1 min to 24 h in continuous or batch-type annealing process.

27. The method of claim 25, further comprising flexibly rolling in at least one rolling step the hot strip or cold strip at a temperature of the hot strip or cold strip of 60° C. to below Ac3, preferably of 60° C. to 450° C.

28. The method of claim 27, further comprising electrolytically galvanising or hot-dip galvanising the hot strip or cold strip or applying another metal, organic or inorganic coating before or after the flexible rolling.

29. The method of claim 25, further comprising flexibly rolling in at least one rolling step the hot strip or cold ship at a temperature of the hot strip or cold strip of 60° C. to below Ac3, preferably of 60° C. to 450° C., wherein the cold rolling is performed at a temperature prior to the rolling step of 60° C. to below the Ac3 temperature, preferably of 60 to 450° C., and further comprising heating or cooling between rolling passes to 60° C. to below the Ac3 temperature, preferably to 60 to 450° C.

30. A flexibly rolled flat steel product, comprising an alloy composition containing (in wt. %): C: 0.0005 to 0.9; Mn: 4 to 12; Al: to 10; P: <0.1; S: <0.1; N: <0.1; with the remainder being iron including unavoidable steel-associated elements and having a tensile strength Rm of more than 1000 MPa to 2000 MPa and an elongation at fracture A50 of more than 3% to 45%.

31. The flat steel product of claim 30, wherein the flat steel product is galvanised by hot-dipping or electrolytically or is coated metallically, inorganically or organically.

32. The flat steel product of claim 30, wherein the alloy composition contains wt. %:
C: 0.05 to 0.35,
Mn: >5 to <10,
Al: 0.05 to 5, in particular >0.5 to 3.

33. The flat steel product of claim 30, wherein the ahoy composition contains in wt. %:
Si: 0.05-3, preferably 0.1-1.5,
Cr: 0.1-4, preferably >0.5-2.5,
Nb: 0.005-0.4, preferably 0.01-0.1,
V: 0.005-0.6, preferably 0.01-0.3,
Ti: 0.005-0.6, preferably 0.01-0.3,
Mo: 0.005-1.5, preferably 0.01-0.6,
Sn: <0.2, preferably <0.05,
Cu: <0.5, preferably <0.1,
W: 0-5, 0.01-3, preferably 0.2-1.5,
Co: 0.01-5, preferably 0.3-2,
Zr: 0.005-0.3, preferably 0.01-0.2,
Ta: 0.005-0.3, preferably 0.01-0.1,
Te: 0.005-0.3, preferably 0.01-0.1,
B: 0.001-0.08, preferably 0.002-0.01.

34. The flat steel product of claim 30, wherein the flat steel product is used in the automotive industry, agricultural engineering, rail vehicle construction, traffic engineering, household appliance or as tailored welded blank.
